(19) United States
(12) Patent Application Publication
(10) Pub. No.: US 2025/0250184 A1
(43) Pub. Date: Aug. 7, 2025

(54) CARTRIDGE WITH INTEGRATED POWER SUPPLY FOR ELECTROCHEMICAL WATER TREATMENT

(71) Applicant: PowerTech Water, Inc., Lexington, KY (US)

(72) Inventors: Keith Jacobs, Loveland, OH (US); Glen Wernersbach, Cincinatti, OH (US); Gregg Dewenter, Bellbrook, OH (US)

(73) Assignee: PowerTech Water, Inc., Lexington, KY (US)

(21) Appl. No.: 19/045,681

(22) Filed: Feb. 5, 2025

Related U.S. Application Data
(60) Provisional application No. 63/550,565, filed on Feb. 6, 2024.

(51) Int. Cl. C02F 1/461

(52) U.S. Cl. CPC C02F 1/46109; C02F 2001/46133; C02F 2201/004; C02F 2201/006; C02F 2201/46125; C02F 2201/46155; C02F 2201/4616; C02F 2301/08

(57) ABSTRACT

Disclosed herein are an electrochemical devices, systems, and methods for purifying an aqueous solution. The devices, systems, and methods include a filtration cartridge with an electrochemical electrode stack and a power supply directly mounted to a surface of the filtration cartridge, the power supply directly supplies power to the filtration cartridge.

### CROSS REFERENCE TO RELATED APPLICATION

This application claims the benefit of U.S. Provisional Patent Application No. 63/550,565 filed Feb. 6, 2024, which is incorporated by reference herein in its entirety.

### BACKGROUND

The present disclosure relates to electrochemical filtration devices, systems, and methods of making and using thereof.

Filtration devices are used to purify fluids, i.e. liquids and gases, in commercial, industrial, and residential applications. The filter medium, which is selected to remove specific contaminants, can be arranged in an enclosed container to allow a fluid to be directed into the container, to come in contact with the filter medium, and to be released out of the container in a purified state. When the filter medium is enclosed within a container, the container can entrain or capture contaminants, and subsequently, the spent filter medium can be disposed together with its container, allowing for clean and safe removal and disposal of the contaminated filter medium. Alternatively, the filter medium may be regenerated and reused.

Electrochemical cells, which can be in the form of cartridges with enclosed filter media, for removing heavy metals include one or more pairs of electrodes, an anode and a cathode (which are the filter media), that removes or reduces the concentration of target species from an input stream and thereby provides an output stream with decreased content of the target species. In particular, when a sufficient external voltage (i.e., potential) is applied to the electrodes, non-spontaneous chemical reactions occur that reduce the concentration of target species (e.g., metal ions, halide ions, derivatives of target metals or target halides, or particulate metals) in the aqueous solution. Depending on the process conditions, e.g., applied voltage, pH, type and concentration of target species, electrode spacing, and cell design, target species are selectively removed from the aqueous solution by various processes, including but not limited to physical adsorption to an electrode; electrical attraction (i.e., capacitive adsorption) to an electrode; and/or electron transfer reactions that directly or indirectly create new target species (i.e., Faradaic reactions) that become immobilized on an electrode.

### SUMMARY

For a more complete understanding of this disclosure, reference is now made to the following brief description, taken in connection with the accompanying drawings and detailed description.

An electrochemical device includes a filtration cartridge comprising an electrochemical electrode stack; and a power supply directly mounted to a surface of the filtration cartridge to supply power directly to the filtration cartridge.

In some embodiments, the electrochemical electrode stack comprises one or more carbon electrodes.

In some embodiments, the electrochemical electrode stack comprises one or more metal-based electrodes.

In some embodiments, the power supply comprises a printed circuit board.

In some embodiments, the electrochemical device further comprises a heat sink surrounding the power supply.

In some embodiments, the heat sink is a cover on top of the filtration cartridge.

In some embodiments, the power supply comprises a plurality of busbars.

According to one or more embodiments, an electrochemical device includes a first portion; a second portion comprising a filtration cartridge and connected to the first portion via conductive connectors; and a power supply connected to the first portion via the conductive connectors.

In some embodiments, the conductive connectors comprise a plurality of metal rods that support an electrochemical electrode stack in the second portion.

In some embodiments, the electrochemical electrode stack further comprises a plurality of anodes and a plurality of cathodes.

In some embodiments, the plurality of metal rods comprises two metal rods connected to the plurality of anodes and two metal rods connected to the plurality of cathodes.

In some embodiments, the power supply comprises a plurality of busbars.

In some embodiments, the plurality of busbars includes conductive material.

In some embodiments, the power supply is connected to the first portion with at least one fastener.

In some embodiments, the electrochemical device further comprises a heat sink surrounding the power supply.

In some embodiments, the power supply is a module power controller.

In other embodiments, an electrochemical system for purifying an aqueous solution includes a docking plate; a docking face mounted to the docking plate; and at least one electrochemical cartridge comprising an electrochemical electrode stack; and a power supply directly mounted to a surface of the at least one electrochemical cartridge to supply power directly to the at least one electrochemical cartridge.

In some embodiments, the electrochemical system further comprises a fan mounted to the docking plate.

In some embodiments, the at least one electrochemical cartridge is a series of electrochemical cartridges.

In some embodiments, the series of electrochemical cartridges are electrically connected to the docking plate.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

For a more complete understanding of this disclosure, reference is now made to the following brief description, taken in connection with the accompanying drawings and detailed description, wherein like reference numerals represent like parts:

FIG. 1 is an exploded view of a filtration cartridge with an integrated power supply and heat sink according to some embodiments;

FIG. 2 is an exploded view of an assembled filtration cartridge with a power supply and heat sink according to some embodiments;

FIG. 3 is a bottom view of a power supply with busbars and pass-throughs for leads according to some embodiments;

FIG. 4A is a perspective view of a docking plate according to some embodiments;

FIG. 4B is a perspective view of a docking plate and filtration cartridge with an integrated power supply and heat sink according to some embodiments; and

FIG. 5 is a perspective view of a filtration cartridge with an integrated power supply and heat sink according to some embodiments.

### DETAILED DESCRIPTION

For practical reasons (e.g., ease of engineering, desire to keep water being treated separate from sensitive electronics), electrochemical systems generally maintain the power supply separate from the system with wires running to the electrical leads. However, such configuration presents challenges, such as resistive losses (IR) from the cables, wires, and other electrical connections.

Because overheating can cause electrical damage to the devices and systems, electrochemical systems must also include a fan to prevent the power supply from overheating. However, the required fan raises the cost of the systems/devices, as well as increases the physical footprints of the systems.

Accordingly, described herein are electrochemical filtration devices/cartridges/systems with power supplies directly mounted onto a surface of the device/cartridge to directly supply power without long cables, wires, and/or electrical connections to the power supply. The electrochemical devices/cartridges/systems are used to treat liquid streams. Mounting the power supply directly onto the filtration cartridge electrochemical device mitigates the undesired consequences of including the power supply separate from the device, and with long wiring/electrical connections extending from the power supply to the device. The electrical port, when connected to an external power source, supplies electrical power to the entire power supply and in turn to the directly connected cartridge. In one or more embodiments, the electrochemical filtration devices/cartridges/systems with directly mounted power supplies further include a heat sink mounted on top of and surrounding the power supply to dissipate heat for the same purpose. The heat sink arranged on top of the power supply allows built-up heat to dissipate and prevents the power supply from overheating to failure.

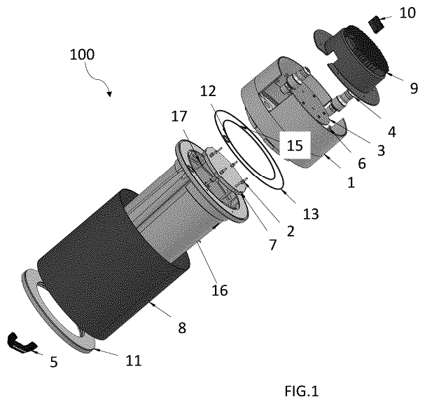

Referring to FIGS. 1, 2, and 5, in one or more embodiments, an electrochemical device 100 includes a power supply 3 is directly mounted to filtration cartridge within second portion 16. The power supply 3 is housed in first portion 1, which directly mounts to the filtration cartridge within the second portion 16 via a plurality of short conductive rods 4 extending from the second portion. The filtration cartridge includes an electrochemical electrode stack described in further detail below.

In one or more embodiments, the short conductive rods have a length of about 3 to about 18 inches, in contrast to conventional wires with longer lengths of 18 inches or more, e.g., about 18 to about 24 inches or longer.

As used herein, “directly mounted” when used with respect to the power supply 3 and filtration cartridge, means that the power supply 3 is directly connected on or to, directly attached to, and/or directly configured via one or more conductive connectors, to the filtration cartridge, with or without housings such as first portion 1 and second portion 16.

In some embodiments, a first portion 1 (FIG. 1) of the electrochemical device 100 is connected to the second portion 15 via a plurality of conductive rods 4 extending from a second portion 16.

The power supply 3 is a device that converts electric current from a source to the correct voltage, current, and frequency to power the electrochemical device 100. According to one or more embodiments, the power supply 3 includes a printed circuit board (PCB), a plurality of busbars, or a combination thereof. In one or more embodiments, the power supply is a proprietary Module Power Controller (MPC board).

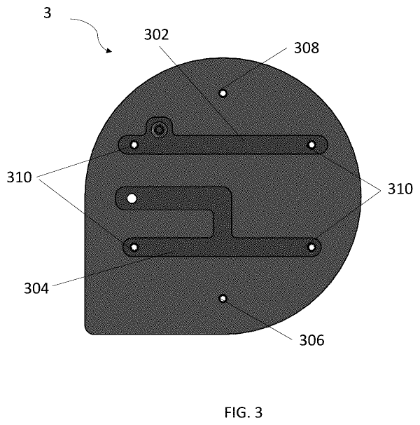

As shown in FIG. 3, the plurality of conductive busbars is integrated and arranged directly onto a surface of the power supply 3, and in particular, extend directly from the surface facing the second portion 16 with the filtration cartridge (see FIG. 1). The plurality of conductive busbars includes a negative power busbar 302 and positive power busbar 304.

Each of the plurality of busbars (negative power busbar 302 and positive power busbar 304) is a thick metallic bar or strip that conducts electricity across the power supply 3 and electrical components. The plurality of busbars includes one or more conductive materials, including but not limited to copper, brass, aluminum, or a combination thereof.

The plurality of busbars not only provides electrical conductivity to the power supply 3, but it also provides structural integrity due to the large cross-sectional areas of the conductive strips relative to the power supply 3 surface. The plurality of busbars withstands mechanical stress under high electrical currents and act as a rigid conductor. The plurality of busbars replaces the long jumper cables that would otherwise connect to the conductive rods 4 (or positive and negative leads).

The POL voltage, or the voltage forced out of the power supply 3, is transmitted directly to the filtration cartridge of the second portion 16 via a plurality of pass-through holes 310 (see FIG. 3) in the power supply 3 board. In conventional devices with jumper cables, the POL voltage is always higher than the filtration cartridge “sensing” voltage, which is due to, for example, conductors in the cables, the device stack, and the diode. The plurality of busbars eliminates or mitigates these losses by transmitting voltage directly to the filtration cartridge by forcing the voltage out through a plurality of pass-through holes 310 that directly contact the plurality of conductive rods 4. In contrast to such conventional devices with jumper cables, which experience resistive losses, the plurality of busbars eliminates or mitigates these losses by measuring or sensing the voltage, rather than applying it. In particular, the plurality of busbars measures the electrical potential difference, or voltage, between the anode and cathode, which is converted into a signal that can be monitored and analyzed.

In some embodiments, each of the busbars of the plurality of busbars has a width of about 0.25 to about 0.5 inches. In other embodiments, each of the busbars of the plurality of busbars have a length of about 3 to 5.5 inches. Still, in other embodiments, each of the busbars of the plurality of busbars has a width of about or in any range between about 0.25, 0.5, 0.75, 1.0, 1.25, 1.5, 1.75, 2.0, 2.25, 2.5, 2.75, 3.0, 3.25, 3.5, 3.75, 4.0, 4.25, 4.5, 4.75, 5.0, 5.25, and 5.5 inches.

The plurality of busbars includes two busbars, a negative power busbar 302 and positive power busbar 304. In some embodiments, the power supply 3 is designed to match the size and dimensions of a cross-section of the electrochemical device 100 or filtration cartridge in the second portion 16, comprised of first portion 1 and second portion 16. For example, the power supply 3 can have a circular shape, a square shape, a teardrop-shape, or any combination thereof, but is not limited to these shapes.

The negative power busbar 302 and the positive power busbar 304 have shapes that are the same or different. Non-limiting examples of shapes for the plurality of busbars include a U-shape, a T-shape, an L-shape, or a combination thereof.

In some embodiments, the power supply 3 is directly coupled to the first portion 1 of the electrochemical device 100 via one or more conductive connectors 6 (see FIG. 1). The second portion 16 that includes the filtration cartridge is connected to the first portion 1 via the conductive connectors 6. The power supply 3 is connected to the first portion 1 via the conductive connectors 6.

The one or more conductive connectors 6 include but are not limited to fasteners, screws, bolts, rivets, nails, washers, nuts, anchors, or any combination thereof. In some embodiments, the one or more conductive connectors 6 include 1, 2, 3, 4, 5, 6, 7, 8, 9, or 10 conductive connectors.

In some embodiments, the one or more conductive connectors 6 include a plurality of metal rods that support the electrochemical electrode stack in the second portion 16. In one or more embodiments, the plurality of metal rods includes two metal rods connected to the plurality of anodes and two metal rods connected to the plurality of cathodes of the electrochemical electrode stack.

Although one or more conductive connectors 6 are shown in FIG. 1 to couple the first portion 1 housing the power supply 3 directly to the second portion 16, one or more conductive connector 6 are not required. The first portion 1 can be attached or connected to the second portion 16 by methods that do not include one or more connectors. In some embodiments, the power supply 3 is connected to the first portion 1 with at least one fastener.

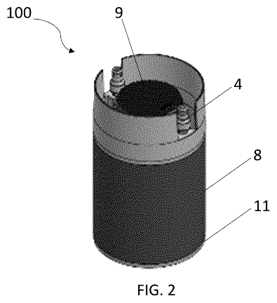

The plurality of conductive rods 2 (see FIGS. 1 and 2) are metal leads and supports on which the electrochemical electrode stack in the filtration cartridge is built. The plurality of conductive rods 4 are directly connected to the anode and the cathode extend of the filtration cartridge housed in the second portion 16, onto which the power supply 3 is placed and secured.

In some embodiments, the plurality of conductive rods 2 include one or more conductive metals. In other embodiments, the plurality of conductive rods 2 includes four rods. Non-limiting examples of conductive materials for the conductive rods 2 include various grades of stainless steel (304, 316, etc.), titanium, copper, or a combination thereof.

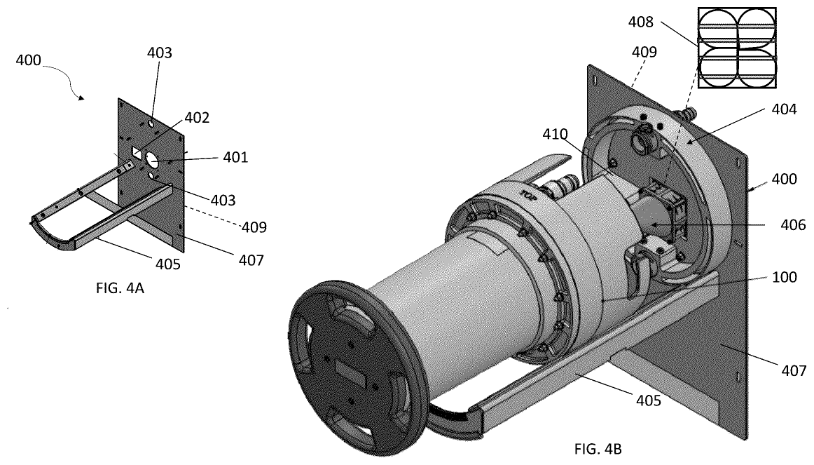

In some embodiments, the power supply 3 includes a plurality of guide pins (not shown) to assist in aligning with the docking plate 400 (FIGS. 4A and 4B).

In some embodiments, the filtration cartridge within the second portion 16 includes an electrochemical electrode stack with a plurality of anodes and a plurality of cathodes. As shown in FIG. 1, two conductive rods 2 of the plurality of conductive rods 2 connect to the anodes of the electrode stack, and two conductive rods 2 connect to the cathodes of the electrode stack.

In one or more embodiments, the electrochemical device 100 includes a heat sink 9, which collects and transfers heat generated by the power supply 3 away from the device and into the surrounding air. In one or more embodiments, the heat sink 9 is a cover that encloses the power supply 3 on top of the filtration cartridge in the second portion 16. In some embodiments, the heat sink 9 is an aluminum cover on top of the filtration cartridge. In one or more embodiments, the heat sink 9 surrounds the power supply 3.

The heat sink 9 has a structure that maximizes its surface area contact with the cooling air to transfer excess heat generated by the electrochemical device 100 to the external air, which enables the electrochemical device 100 to maintain a regulated temperature and thereby improve performance that would normally affected by overheating that leads to failure. A non-limiting example of a material for the heat sink 9 includes aluminum.

The heat sink 9 includes a plurality of fins on the top external (end) surface facing the external air to passively dissipate heat away from the electrochemical device 100 into the environment. In some embodiments, one or more fans 408 (FIG. 4B) or another mechanism to force air flow across the fin containing surface is used to further aid in cooling the electrochemical device 100.

In some embodiments, the electrochemical device 100 couples to a docking plate 400 as shown in FIGS. 4A and 4B. The docking plate 400 includes a cartridge bracket 405 that extends from back plate 409. The electrochemical device 100 rests on the cartridge bracket.

In one or more embodiments, a docking face 407 is mounted to the back plate 409 with plumbing connectors for coupling to plumbing connectors on the electrochemical device 100. The docking face 407 guides the electrochemical device 100 into place on the docking plate 400.

In some embodiments, the docking plate 400 includes fluid flow apertures 403 a fan connection aperture 401, and an electrical connection aperture 402. The fluid flow aperture 403 provide pathways for circulating fluid through the filtration cartridge.

The fan connection aperture 401 is a connection pathway (pass-through) for coupling the fan 408 on the opposite side of the back plate 409. In some embodiments, the fan 408 is mounted to the back plate 409 of the docking plate to provide additional cooling. In other embodiments, the fan 408 is arranged on an opposite side of the back plate 409 from the electrochemical device 100. In some embodiments, a cooling funnel 406 is connected to the fan connection aperture 401 to direct air across or over the power supply 3.

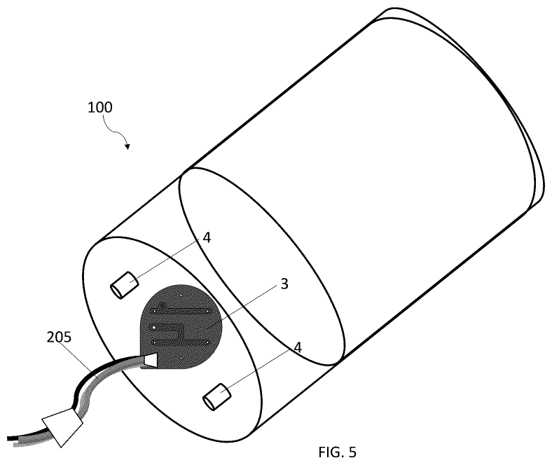

The electrical connector 10 (see FIG. 1) mates with the docking plate electrical connector 410. The electrical connector 10 connects to the power supply 3 via a wire (one of the wires of the plurality of wires 205 shown in FIG. 5). The plurality of wires 205 extend from the power supply through the connection pathway in the heat sink 9 to electrical connector 10. The electrical connector 10 is connected through the electrical connection aperture 402 in the docking plate 400 to an extrinsic power source, which powers the electrochemical device 100.

One or more conductive contacts 2 (or drop-downs) couple the power supply 3 surface to the heat sink 9. The one or more conductive contacts 2 contact the high temperature components of the power supply 3 surface to funnel heat away from the device and dissipate heat into the heat sink 9. A non-limiting example of a material for the one or more conductive contacts is aluminum.

In one or more embodiments, the heat sink 9 is an aluminum cover on top of the filtration cartridge, and the aluminum cover further comprises aluminum conductive contacts 2 (or drop-downs) to contact the power supply.

In one or more embodiments, one or more thermal pads (not shown) are placed between the conductive contacts 2 and the power supply 3 to ensure appropriate contact with the power supply 3 and conduct teat efficiently from the high temperature surface of the power supply 3 to the heat sink 9. The one or more thermal pads cover components that may be overheated. Once the one or more thermal pads is placed between the conductive contacts 2 and the power supply 3, the material softens, fills the surface gaps between the components, and boosts heat transfer.

In some embodiments, the one or more thermal pads is made of a material that is non-electrically conductive and highly heat conductive. In other embodiments, the one or more thermal pads are pre-formed sheets of solid material made of a wax, silicone, or synthetic matrix that are filled with a composition of thermally conductive microparticles.

In one or more embodiments, the electrochemical device 100 includes a filtration cartridge support plate 7 (or bracing), at a terminal end of the filtration cartridge.

The electrochemical device 100 includes an external housing 8 to surround and protect the second portion 16 with the filtration cartridge.

In one or more embodiments, the electrochemical device 100 includes a gasket 13 (such as an o-ring) between the first portion 1 and second portion 16. The gasket 13 is arranged in a groove on a terminal end of the first portion 1 or second portion 16 and compressed during assembly of the two parts to form a seal at the interface.

In some embodiments, the electrochemical device 100 includes one or more gaskets 12, 15, which are smaller in size than the gasket 13, and that are also arranged between first portion 1 and second portion 16. These one or more gaskets 12, 15 are compressed during assembly and form a seal at the interface. The gaskets 12, 15 are arranged in the same manner as gasket 13.

The gaskets 12, 13 and 15 include a loop of an elastomeric material(s) with a round cross-section. Non-limited examples of materials for the gaskets 12, 13 and 15 include a fluoroelastomer. The materials used for the gaskets 12, 13 and 15 can be the same or different.

In some embodiments, the electrochemical device 100 includes a cap 11 arranged on an end of the second portion 16. In other embodiments, the electrochemical device 100 further includes an optional pull handle 5 for easy removal of the filtration cartridge from the docking plate 400.

In some embodiments, the electrochemical device 100 further includes a seal 17 between the top of the filtration cartridge within the second portion 16 and the bottom of the housing around the plurality of rods 2, which prevents any liquid from leaking out of the cartridge. In other embodiments, the electrochemical device 100 further includes a cartridge electrode bracing 7.

In one or more embodiments, heat flows through the electrochemical device/system as follows:
power supply hot components→thermal pads→aluminum drop downs (or copper heat tubes)→heat sink→plurality of fins→air

In some embodiments, the electrochemical device 100 with the filtration cartridge in the second portion 16, power supply 3, and heat sink 9 is modular, and a series of said cartridges can be electrically connected to the docking plate 400 weldment and powered at the same time to form a system.

In some embodiments, systems for purifying an aqueous solution include a docking plate, a docking face mounted to the docking plate, at least one electrochemical cartridge comprising an electrochemical electrode stack, and a power supply directly mounted to a surface of the electrochemical cartridge to supply power directly to the electrochemical cartridge. In some embodiments, the systems further include a fan mounted to the docking plate. In other embodiments, the at least one electrochemical cartridge is a series of electrochemical cartridges. In one or more embodiments, the series of electrochemical cartridges are electrically connected to the docking plate.

While there is no restriction on the orientation of the modular filter, a horizontal orientation can be convenient. Thus, in some embodiments, the longitudinal axis of the filtration module is horizontal or nearly horizontal. “Nearly horizontal”, as used herein, refers to an orientation of 180±10°. A horizontal orientation is advantageous, because it lends itself to quick and easy replacement of modular filters by an operator.

In some embodiments, the modular filter comprises an outer hollow cylinder, an inner hollow cylinder, a front cap, and a back cap. The outer hollow cylinder, inner hollow cylinder, front cap, and back cap define a hollow, cylindrical, annular space for placement of a plurality of electrodes. Thus, in some embodiments, each of the plurality of electrodes is wrapped around an inner cylinder and encased by an outer cylinder, wherein the inner cylinder, the plurality of electrodes, and the outer cylinder are coaxial.

In some embodiments, the filtration cartridge in the second portion 16 is an electrochemical device for purifying an aqueous solution. The electrochemical device can be, for example, a deionization cell comprising a plurality of electrodes. The plurality of electrodes in the deionization cell are exposed to an input aqueous solution stream with an outlet for an output aqueous solution, or waste, stream. An open circuit configurable option, a power supply, and a means for controlling the power supply are connected to the electrodes. Optionally, the deionization cell has a means for controlling the input stream and the output stream. Purifying is done by application of an electrical potential difference over two electrodes in the deionization cell. In some embodiments, a positive voltage is applied to anode electrodes and a negative voltage is applied to cathode electrodes, which results in migration and adsorption of negative ions on the anodes and simultaneous migration and adsorption of positive ions on the cathodes.

When the filtration cartridge includes a plurality of electrodes, the plurality of electrodes can be in an electrochemical stack or in a rolled configuration. In some embodiments of the filtration device, the plurality of electrodes is in a rolled configuration. In other embodiments of the filtration device, the plurality of electrodes is in a stacked configuration.

The filtration cartridge is, for example, at least one capacitive deionization (CDI) cell, membrane capacitive deionization (MCDI) cell, inverted capacitive deionization (i-CDI) cell, capacitive coagulation cell (CCC), electrodialysis reversal (EDR) cell, or faradaic porosity cell (FPC). In some embodiments, the cell is a capacitive deionization (CDI) cell, an inverted capacitive deionization (i-CDI) cell, or a faradaic porosity cell (FPC).

In some embodiments, the plurality of electrodes of the filtration cartridge includes one or more carbon electrodes. In other embodiments, the electrochemical stack includes one or more carbon electrodes. The carbon electrode can comprise, for example, at least one of activated carbon, porous carbon, macroporous carbon, mesoporous carbon, microporous carbon, carbon xerogel, carbon aerogel, graphene, carbon nanofibers, carbon nanotubes, surface-modified carbon, silica-coated carbon, carbon block, carbon film, activated carbon film, carbon felt (nonwoven), or carbon cloth (woven).

In other embodiments, the plurality of electrodes comprises one or more of a metal-based electrode. The metal-based electrode can include a metal substrate with a metal oxide coating in some embodiments. In some embodiments, the electrodes are an electrode stack that include one or more metal-based electrodes.

In one or more embodiments, the filtration cartridge includes carbon electrodes and metal electrodes.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of the description hereinafter, the terms “upper,” “lower,” “right,” “left,” “vertical,” “horizontal,” “top,” “bottom,” and derivatives thereof shall relate to the described structures and methods, as oriented in the drawing figures. The terms “overlying,” “atop,” “on top,” “positioned on” or “positioned atop” mean that a first element, such as a first structure, is present on a second element, such as a second structure, wherein intervening elements such as an interface structure can be present between the first element and the second element. The term “direct contact” means that a first element, such as a first structure, and a second element, such as a second structure, are connected without any intermediary conducting, insulating or semiconductor layers at the interface of the two elements.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

While the preferred embodiments to the invention have been described, it will be understood that those skilled in the art, both now and in the future, may make various improvements and enhancements which fall within the scope of the claims which follow. These claims should be construed to maintain the proper protection for the invention first described.

What is claimed is:

1. An electrochemical device comprising:
a filtration cartridge comprising an electrochemical electrode stack; and
a power supply directly mounted to a surface of the filtration cartridge to supply power directly to the filtration cartridge.

2. The electrochemical device of claim 1, wherein the electrochemical electrode stack comprises one or more carbon electrodes.

3. The electrochemical device of claim 1, wherein the electrochemical electrode stack comprises one or more metal-based electrodes.

4. The electrochemical device of claim 1, wherein the power supply comprises a printed circuit board.

5. The electrochemical device of claim 1, further comprising a heat sink surrounding the power supply.

6. The electrochemical device of claim 5, wherein the heat sink is a cover on top of the filtration cartridge.

7. The electrochemical device of claim 1, wherein the power supply comprises a plurality of busbars.

8. An electrochemical device comprising:
a first portion;
a second portion comprising a filtration cartridge and connected to the first portion via conductive connectors; and
a power supply connected to the first portion via the conductive connectors.

9. The electrochemical device of claim 8, wherein the conductive connectors comprise a plurality of metal rods that support an electrochemical electrode stack in the second portion.

10. The electrochemical device of claim 9, wherein the electrochemical electrode stack further comprises a plurality of anodes and a plurality of cathodes.

11. The electrochemical device of claim 10, wherein the plurality of metal rods comprises two metal rods connected to the plurality of anodes and two metal rods connected to the plurality of cathodes.

12. The electrochemical device of claim 8, wherein the power supply comprises a plurality of busbars.

13. The electrochemical device of claim 12, wherein the plurality of busbars includes conductive material.

14. The electrochemical device of claim 8, wherein the power supply is connected to the first portion with at least one fastener.

15. The electrochemical device of claim 8, further comprising a heat sink surrounding the power supply.

16. The electrochemical device of claim 8, wherein the power supply is a module power controller.

17. An electrochemical system for purifying an aqueous solution comprising:
a docking plate;
a docking face mounted to the docking plate; and
at least one electrochemical cartridge comprising an electrochemical electrode stack; and
a power supply directly mounted to a surface of the at least one electrochemical cartridge to supply power directly to the at least one electrochemical cartridge.

18. The electrochemical system of claim 17, further comprising a fan mounted to the docking plate.

19. The electrochemical system of claim 17, wherein the at least one electrochemical cartridge is a series of electrochemical cartridges.

20. The electrochemical system of claim 19, wherein the series of electrochemical cartridges are electrically connected to the docking plate.
